(19) United States
(12) Patent Application Publication
(10) Pub. No.: US 2023/0206103 A1
(43) Pub. Date: Jun. 29, 2023

(54) CHARACTERIZATION OF QUANTUM COMPUTER PERFORMANCE

(71) Applicant: BEIJING BAIDU NETCOM SCIENCE TECHNOLOGY CO., LTD., Beijing (CN)

(72) Inventor: Kun WANG, Beijing (JP)

(73) Assignee: BEIJING BAIDU NETCOM SCIENCE TECHNOLOGY CO., LTD., Beijing (JP)

(21) Appl. No.: 18/120,348

(22) Filed: Mar. 10, 2023

(30) Foreign Application Priority Data
Mar. 14, 2022 (CN) 202210249419.5

(51) Int. Cl. G06N 10/20

(52) U.S. Cl. CPC G06N 10/20

(57) ABSTRACT

A method is provided which includes: obtaining a set of sequence lengths for performing randomized benchmarking on the quantum computer; performing, for each m, the following operations R times: obtaining m quantum gates that are randomly generated, and quantum gates corresponding to respective inverse operations of the m quantum gates; constructing a quantum circuit, wherein the m quantum gates are sequentially connected in a first order, and the quantum gates corresponding to the respective inverse operations of the m quantum gates are sequentially connected behind the m quantum gates in an order opposite the first order; applying an initial quantum state to the quantum circuit to perform a plurality of standard basis measurements; and determining a number of occurrences of an all-zero sequence; fitting an objective function based on an average expected value corresponding to each m obtained after R operations; and determining an average precision of the quantum computer.

### CROSS REFERENCE TO RELATED APPLICATIONS

The present application claims priority to Chinese Patent Application No. 202210249419.5 filed on Mar. 14, 2022, the content of which is hereby incorporated by reference in its entirety for all purposes.

### TECHNICAL FIELD

The present disclosure relates to the field of computers, in particular to the technical field of quantum computers, in particular to a method and device for characterizing the performance of a quantum computer, an electronic device, a computer readable storage medium and a computer program product.

### BACKGROUND

A quantum computer technology has developed rapidly in recent years, and the powerful computing power of quantum computers is expected to solve many problems that are difficult to be solved by classical computers. However, in the foreseeable future, the noise problem in quantum computers is inevitable: heat dissipation in qubits or random fluctuations in a lower-level quantum physical process will make the state of qubits flip or randomize, and the computing results read by measuring equipment will deviate, which may lead to the failure of the computing process. Thus, the quantum computers may not be able to accurately implement the evolutionary process, resulting in errors in the actual generated results.

Therefore, prior to using quantum computers to do any meaningful computing tasks, it would be necessary to be able to characterize the performance of the quantum computers quickly, efficiently and accurately, so as to determine, based on the characterization results, whether the quantum computers can be used in an actual quantum computing process.

### SUMMARY

The present disclosure provides a method and device for characterizing the performance of a quantum computer, an electronic device, a computer readable storage medium, and a computer program product.

According to one aspect of the present disclosure, provided is a method for characterizing a performance of a quantum computer, including: obtaining a set of sequence lengths for performing randomized benchmarking on the quantum computer; performing, for each sequence length m in the set of sequence lengths, the following operations for R times, wherein m and R are both positive integers: obtaining m n-bit quantum gates that are randomly generated, and quantum gates corresponding to respective inverse operations of the m n-bit quantum gates, wherein n is a positive integer; constructing a quantum circuit, wherein in the quantum circuit, the m n-bit quantum gates are sequentially connected in a first order, and the quantum gates corresponding to the respective inverse operations of the m n-bit quantum gates are sequentially connected behind the m n-bit quantum gates in an order opposite to the first order; applying an initial quantum state to the quantum circuit to perform a plurality of standard basis measurements on a quantum state output by the quantum circuit; and determining a number of occurrences of an all-zero sequence in the plurality of standard basis measurements to calculate an expected value based on the number of occurrences; determining, for each sequence length m, an average expected value obtained after R operations; fitting an objective function based on the average expected value corresponding to each sequence length m, wherein for each sequence length m, a highest power of the objective function is 2m−1; and determining an average precision of the quantum computer implementing a n-bit quantum gate based on a result of the fitting.

According to another aspect of the present disclosure, provided is an electronic device, including: a memory storing one or more programs configured to be executed by one or more processors, the one or more programs including instructions for causing the electronic device to perform operations comprising: obtaining a set of sequence lengths for performing randomized benchmarking on a quantum computer; performing, for each sequence length m in the set of sequence lengths, the following operations for R times, wherein m and R are both positive integers: obtaining m n-bit quantum gates that are randomly generated, and quantum gates corresponding to respective inverse operations of the m n-bit quantum gates, wherein n is a positive integer; constructing a quantum circuit, wherein in the quantum circuit, the m n-bit quantum gates are sequentially connected in a first order, and the quantum gates corresponding to the respective inverse operations of the m n-bit quantum gates are sequentially connected behind the m n-bit quantum gates in an order opposite to the first order; applying an initial quantum state to the quantum circuit to perform a plurality of standard basis measurements on a quantum state output by the quantum circuit; and determining a number of occurrences of an all-zero sequence in the plurality of standard basis measurements to calculate an expected value based on the number of occurrences; determining, for each sequence length m, an average expected value obtained after R operations; fitting an objective function based on the average expected value corresponding to each sequence length m, wherein for each sequence length m, a highest power of the objective function is 2m−1; and determining an average precision of the quantum computer implementing a n-bit quantum gate based on a result of the fitting.

According to another aspect of the present disclosure, provided is a non-transitory computer readable storage medium that stores one or more programs comprising instructions that, when executed by one or more processors of a computing device, cause the computing device to implement operations comprising: obtaining a set of sequence lengths for performing randomized benchmarking on a quantum computer; performing, for each sequence length m in the set of sequence lengths, the following operations for R times, wherein m and R are both positive integers: obtaining m n-bit quantum gates that are randomly generated, and quantum gates corresponding to respective inverse operations of the m n-bit quantum gates, wherein n is a positive integer; constructing a quantum circuit, wherein in the quantum circuit, the m n-bit quantum gates are sequentially connected in a first order, and the quantum gates corresponding to the respective inverse operations of the m n-bit quantum gates are sequentially connected behind the m n-bit quantum gates in an order opposite to the first order; applying an initial quantum state to the quantum circuit to perform a plurality of standard basis measurements on a quantum state output by the quantum circuit; and determining a number of occurrences of an all-zero sequence in the plurality of standard basis measurements to calculate an expected value based on the number of occurrences; determining, for each sequence length m, an average expected value obtained after R operations; fitting an objective function based on the average expected value corresponding to each sequence length m, wherein for each sequence length m, a highest power of the objective function is 2m−1; and determining an average precision of the quantum computer implementing a n-bit quantum gate based on a result of the fitting.

It should be understood that the content described in this part is not intended to identify key or important features of the embodiments of the present disclosure, nor is it intended to limit the scope of the present disclosure. Other features of the present disclosure will be readily understood by the following description.

### BRIEF DESCRIPTION OF THE DRAWINGS

The accompanying drawings exemplarily illustrate the embodiments and constitute a part of the description, and together with the written description of the description, serve to teach exemplary implementations of the embodiments. The illustrated embodiments are merely for illustrative purposes, and do not limit the scope of the claims. Throughout the drawings, same reference signs refer to similar, but not necessarily identical, elements.

FIG. 1 shows a schematic diagram of an exemplary system for obtaining classical information by a quantum computer;

FIG. 2 shows a schematic diagram of a standard randomized benchmarking circuit according to an embodiment of the present disclosure;

FIG. 3 shows a schematic diagram of a cross entropy benchmarking circuit according to an embodiment of the present disclosure;

FIG. 4 shows a flowchart of a method for characterizing a performance of a quantum computer according to an embodiment of the present disclosure;

FIG. 5 shows a schematic diagram of a randomized benchmarking circuit according to an exemplary embodiment of the present disclosure;

FIG. 6 shows a schematic diagram of a noisy randomized benchmarking circuit according to an exemplary embodiment of the disclosure;

FIG. 7 shows a schematic diagram of randomized benchmarking results of depolarized channel noise according to an embodiment of the present disclosure;

FIG. 8 shows a schematic diagram of randomized benchmarking results of amplitude damping channel noise according to an embodiment of the present disclosure;

FIG. 9 shows a schematic diagram of randomized benchmarking results of bit-flip channel noise according to an embodiment of the present disclosure;

FIG. 10 shows a structural block diagram of a device for characterizing the performance of a quantum computer according to an embodiment of the present disclosure; and

FIG. 11 shows a structural block diagram of an exemplary electronic device that can be used to implement the embodiments of the present disclosure.

### DETAILED DESCRIPTION

Exemplary embodiments of the present disclosure are described below in connection with the accompanying drawings, including various details of the embodiments of the present disclosure for ease of understanding, which should be considered to be merely exemplary. Accordingly, those of ordinary skill in the art will recognize that various changes and modifications can be made to the embodiments described herein without departing from the scope of the present disclosure. Likewise, descriptions of well-known functions and structures are omitted in the following description for clarity and conciseness.

In the present disclosure, unless otherwise specified, the use of the terms “first”, “second” and the like to describe various elements is not intended to define a positional, temporal, or importance relationship of these elements, and such terms are merely used to distinguish one element from another. In some examples, a first element and a second element may refer to a same instance of this element, while in some cases, based on the context description, they may also refer to different instances.

The terms used in the description of the various described examples in the present disclosure are for the purpose of describing particular examples only and are not intended to be limiting. Unless the context clearly indicates otherwise, if the number of elements is not specifically defined, the element can be one or more. Furthermore, the term “and/or” as used in the present disclosure encompasses any and all possible combinations of the listed items.

The embodiments of the present disclosure will be described in detail below with reference to the accompanying drawings.

So far, various types of computers in application use classical physics as a theoretical basis for information processing, which are called traditional computers or classical computers. Classical information systems store data or programs with binary data bits that are physically the easiest to implement, each binary data bit is represented by 0 or 1, called a bit or bit, as a smallest information unit. Classical computers themselves have unavoidable weaknesses: firstly, the most basic limitation of energy consumption in the computing process. The minimum energy required by a logic element or a storage unit should be several times of kT or above to avoid misoperation during thermal fluctuation; secondly, information entropy and heating energy consumption; and thirdly, when the wiring density of computer chips is large, according to the Heisenberg uncertainty relationship, if the uncertainty of an electronic position is very small, the uncertainty of momentum will be very large. The electrons are no longer bound, there will be quantum interference effects that can even destroy the performance of the chip.

Quantum computers are a class of physical devices that follow the properties and laws of quantum mechanics to perform high-speed mathematical and logical operations, store and process quantum information. When a certain device processes and computes quantum information and runs a quantum algorithm, it is a quantum computer. Quantum computers follow unique laws of quantum dynamics (in particular quantum interference) to implement a new mode of information processing. Quantum computers have an absolute advantage over classical computers in speed for parallel processing of computing problems. The transformation achieved by the quantum computer for each superposed component is equivalent to a classical computation, all of these classical computations are done simultaneously and superposed with a certain probability amplitude to give the output result of the quantum computer, and thus, this computation is called quantum parallel computing. Quantum parallel processing greatly increases the efficiency of the quantum computer so that it can do work that the classical computer cannot do, such as factorization of a large natural number. Quantum coherence has been exploited intrinsically in all quanta ultrafast algorithms. Thus, quantum parallel computing, in which quantum states are substituted for classical states, can achieve incomparable computing speeds and information processing functions of classical computers, while saving substantial computing resources.

With the rapid development of the quantum computer technology, the application range of quantum computers is becoming wider and wider due to its powerful computing power and faster operating speed. For example, chemical simulation refers to a process of mapping Hamiltonian of a real chemical system to a physically operable Hamiltonian, and then modulating parameters and evolution time to find an eigenstate capable of reflecting the real chemical system. When an N-electron chemical system is simulated on a classical computer, it involves the solution of a 2^{N}-dimensional Schrodinger equation, and the amount of computing will increase exponentially with the increase of the number of electrons in the system. Therefore, the role of classical computers in chemical simulation is very limited. To break through this bottleneck, it is necessary to rely on the powerful computing power of quantum computers. A variational quantum eigensolver (VQE), a highly efficient quantum algorithm for chemical simulation on quantum hardware, is one of the most recently promising applications of quantum computers, opening many new areas of chemical research. However, at this stage, the noise rate of the quantum computer significantly limits the capability of VQE, so it is necessary to deal with the quantum noise problem first.

One core computing process of the variational quantum eigensolver (VQE) is to estimate an expected value Tr[Oρ], wherein ρ is a quantum state of n qubits generated by a quantum computer, and an observable quantity O is Hamiltonian of a real chemical system mapped to a physically operable Hamiltonian, and Tr represents trace of a matrix. The computing process may be as shown in FIG. 1, in which a quantum state ρ output by a quantum computer 101 is measured by a measurement device 102 (typically the quantum computer 101 and the measurement device 102 may be collectively referred to as a quantum computer), and its measurement results are computed by a classical computer 103 to obtain the expected value Tr[Oρ]. The above process is a most general form of extraction of classical information by quantum computation, which has a wide range of applications and can be considered as a core step of reading classical information from quantum information. In general, it is assumed that O is a diagonal matrix under the computation basis, so a value to be calculated theoretically is:

$$Tr [ O ρ ] = {\sum }_{i = 0}^{{2}^{n} - 1} O ( i ) ρ ( i ) \qquad Formula ( 1 )$$

wherein O(i) represents a diagonal element in the i-th row and i-th column of the observable quantity O, and ρ(i) represents a diagonal element in the i-th row and i-th column of ρ. The number of times Nᵢ of an output result i is counted by performing N computation basis measurements on the quantum state ρ, and it can be estimated that ρ(i)≈Nᵢ/N, and then Tr[Oρ] is estimated by using the above formula. The law of large numbers may guarantee that the above estimation process is correct when N is large enough.

In physical implementation, due to limitations of a variety of factors such as instruments, methods, conditions, etc., quantum computers can not accurately realize the evolution process, which leads to the deviation between the actual generated quantum state and the expected quantum state ρ, and then leads to the deviation between the actual estimated value Nᵢ/N and theoretical ρ(i). Therefore, a wrong result is obtained by calculating Tr[Oρ] with the formula (1). Typically, the fidelity of single-bit gates can reach 99% or above, but the fidelity of two-bit quantum gates is mostly 92%-97%, which is the main reason for the inaccuracy of quantum computing results. More seriously, as the number of qubits increases and the depth of quantum circuits increases, the sources and correlations of noise will become more complex. Therefore, before using quantum computers to do any meaningful computing tasks, it must be able to quickly, efficiently and accurately characterize the performance of the quantum computers, and determine whether the quantum computers can be used in the actual quantum computing process according to the characterization results. In fact, the efficient and accurate characterization of quantum computers is a very critical task in the development of quantum computing, especially in the current noisy intermediate-scale quantum (NISQ) stage.

At present, the methods used to characterize the performance of quantum devices can be roughly divided into two categories: quantum tomography and benchmarking (randomized benchmarking).

A core idea of the quantum tomography method is to completely compute an actual evolution process of a quantum computer, and then analyze the similarity with expected evolution (such as the fidelity of quantum gates), so as to characterize the performance of the quantum computer. But these methods are too expensive, and quantum resources consumed (the number of quantum states to be prepared & the number of times to be measured) increase exponentially with the increase of the number n of qubits. In physical experiments, quantum computers with more than three qubits need to collect a lot of data to characterize the performance of the device by the quantum tomography method, so it is not practical.

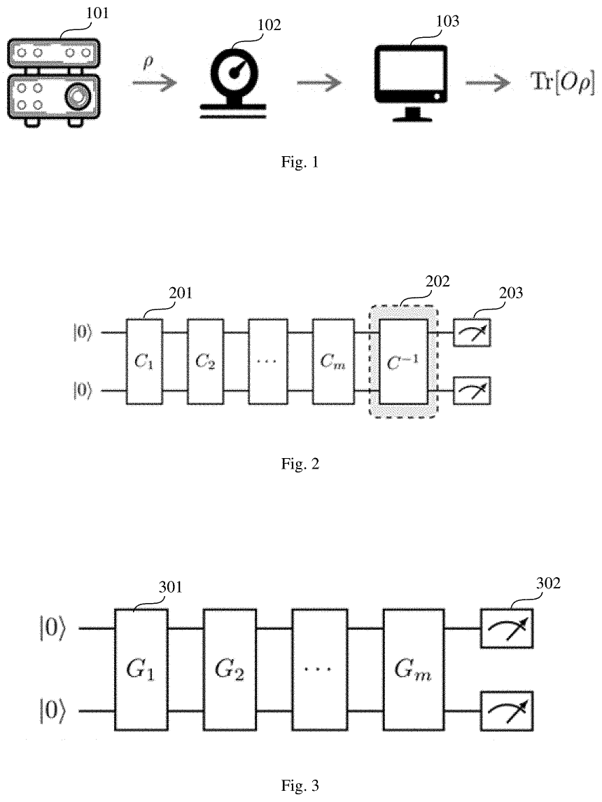

Benchmarking methods include standard randomized benchmarking and cross entropy benchmarking. Standard randomized benchmarking uses a method of random Clifford sequences to benchmark quantum computers, and its schematic diagram is shown in FIG. 2. In a quantum circuit shown in FIG. 2, m Clifford quantum gates 201 are randomly generated and then an inverse quantum gate 202 composed of the m quantum gates is computed. This quantum circuit is applied to an initial state |0 . . . 0> of a system, and finally measurement is performed by a measurement device 203 to count the number of occurrences of an all-zero sequence 0 . . . 0. Ideally, the entire circuit is an “equivalent identity quantum circuit”, i.e., ideally, the effect of the entire quantum circuit is equivalent to an identity matrix, so when the input quantum state is |0 . . . 0>, the measurement result can only be the all-zero sequence 0 . . . 0. In practice, each quantum gate contains noise. The quantum circuit shown in FIG. 2 contains a total of m+1 quantum gates, so the noise can be approximately regarded as being amplified by m+1 times. When the total number of measurements is fixed, the number of the all-zero sequence 0 . . . 0 becomes small. Intuitively, the effect of noise becomes more pronounced as the quantum circuit becomes deeper (i.e., m becomes larger, and the sequence of Clifford quantum gates that are randomly generated becomes longer). The process that the number of observations decreases as the depth of the quantum circuit increases can reflect the quantum noise intensity of the quantum computer.

However, in standard randomized benchmarking, a core step is to compute an inverse quantum gate composed of a string of random Clifford gates (C₁, C₂, . . . , Cₘ), i.e. C⁻¹=(Cₘ . . . C₁)†, wherein † represents the mathematically complex conjugate transpose operation. But the task of “computing an inverse matrix C⁻¹ and splitting it into a combination of fundamental quantum gates” is not easy, and computation needs to be performed once for each random circuit, and the computing cost of classical post-processing is high. One of the important reasons that standard randomized benchmarking chooses random Clifford gates instead of any qubit gates, is that it is very difficult for any string of quantum gates to find an inverse quantum gate composed of the quantum gates, and choosing random Clifford gates can reduce a certain computing difficulty due to their intrinsic symmetry. However, although a certain computing difficulty can be reduced, the computing cost remains high.

Cross entropy benchmarking is a method of evaluating gate performance by applying a random circuit and measuring cross entropy between probabilities of observed output bit strings and expected probabilities of these output bit strings obtained from classical computer simulations. A schematic diagram of cross entropy benchmarking is shown in FIG. 3. In FIG. 3, m n-bit quantum gates 301 are randomly generated, applying to an initial state |0 . . . 0> of a system, and then measurement is performed by a measurement device 302 to count the number of output bit strings. Ideally, the above process is repeatedly performed for many times, an average probability distribution will tend towards a Porter-Thomas distribution, i.e. a probability distribution of the output bit strings of a random quantum circuit is traceable. In practice, each quantum gate contains noise. An average output probability distribution of a quantum circuit shown in FIG. 3 will deviate from the Porter-Thomas distribution, and in an extreme case (e.g., a quantum system being filled with white noise), an output probability distribution of the quantum circuit will become a uniform distribution, thereby completely losing quantum properties. Thus, an average output probability distribution in the actual case can be counted and a distance between the average output probability distribution and an ideal probability distribution is calculated to measure the noise intensity of the quantum computer. Intuitively, as the quantum circuit becomes deeper (i.e., m becomes larger, and the random quantum circuit becomes longer), the effect of noise is more pronounced and the distance between the actual output probability distribution and the ideal probability distribution is greater. In cross entropy benchmarking, cross entropy is typically used as a metric function of distance. The cross entropy of the output probability distribution and the ideal probability distribution of the random quantum circuit is done by numerical simulation by a classical computer. That is, the ideal probability distribution corresponding to the random quantum circuit needs to be computed, so classical computation is costly. In fact, the resource consumption of the theoretical output probability distribution obtained by classical computer numerical simulation increases exponentially with the number of qubits and the depth of the random quantum circuit, so it is not scalable.

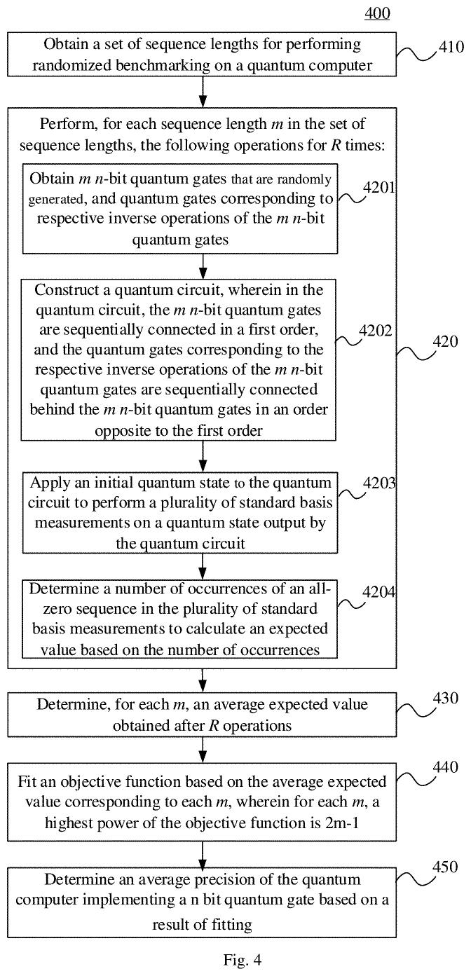

Thus, according to the embodiments of the present disclosure, provided is a method for characterizing the performance of a quantum computer. As shown in FIG. 4, the method 400 includes: obtaining a set of sequence lengths for performing randomized benchmarking on the quantum computer (step 410); performing, for each sequence length m in the set of sequence lengths, the following operations for R times (step 420): obtaining m n-bit quantum gates that are randomly generated, and m quantum gates corresponding to respective inverse operations of the m n-bit quantum gates (step 4201); constructing a quantum circuit, wherein in the quantum circuit, the m n-bit quantum gates are sequentially connected in a first order, and the m quantum gates corresponding to the respective inverse operations of the m n-bit quantum gates are sequentially connected behind the m n-bit quantum gates in an order opposite to the first order (step 4202); applying an initial quantum state to the quantum circuit to perform a plurality of standard basis measurements on a quantum state output by the quantum circuit (step 4203); and determining a number of occurrences of an all-zero sequence in the plurality of standard basis measurements to calculate an expected value based on the number of occurrences (step 4204); determining, for each m, an average expected value obtained after R operations (step 430); fitting an objective function based on the average expected value corresponding to each m, wherein for each m, a highest power of the objective function is 2m−1 (step 440); and determining an average precision of the quantum computer implementing a n-bit quantum gate based on a result of the fitting (step 450).

According to the embodiments of the present disclosure, instead of computing an inverse quantum gate composed of a string of random Clifford gates, it is applicable to any qubit gates, the inverse operation of this string of random quantum gates is directly applied to a system state, saving a significant amount of computing resources of classical post-processing.

In the present disclosure, in order to avoid computing the inverse quantum gate, the inverse effect of quantum gates that are randomly generated can be directly constructed. In a quantum computer, each quantum gate is composed of fundamental quantum gates by building blocks, and its inverse operation is easy to construct. Exemplarily, in a set of universal quantum gates consisting of single-qubit gates H, T, and S and two-qubit gates CNOT , it is only necessary to replace each fundamental quantum gate with the corresponding inverse operation and reverse the order of action, i.e., replace each gate T with T^{†}, replace each gate S with S^{†}, and make H and CNOT remain unchanged, and then reverse the order of action of each quantum gate to realize a quantum gate corresponding to a reverse operation of the corresponding quantum gate.

According to some embodiments, the method 400 may further include determining an average noise intensity of the quantum computer implementing a n-bit quantum gate based on the average precision.

According to some embodiments, the average noise intensity of the quantum computer implementing a n-bit quantum gate is determined according to a formula (2):

$${r}_{E P G} = \frac{{2}^{n} - 1}{{2}^{n}} ( 1 - f ) \qquad Formula ( 2 )$$

wherein f represents a average precision of the quantum computer implementing a n-bit quantum gate that is to be determined.

In one exemplary embodiment according to the present disclosure, the number n of qubits, as well as a set Σ={m₁, m₂, . . . , m_{N}} of sequence lengths for performing randomized benchmarking on a quantum computer are first determined. In some examples, the elements in the set Σ may be agreed to be monotonically increasing to facilitate subsequent fitting of the objective function. Further, the number R of repetitions of each sequence length, the number S of repeated runs of each random circuit, and a set Ω of fundamental gates supported by the quantum computer are determined, wherein each of R, S, N, and n is a positive integer, and a plurality of fundamental quantum gates may be included in the set Ω.

Exemplarily, the set Σ may be copied, denoted by Σ_{bk}. A first element is taken from the set Σ, denoted by m, and m is removed from the set Σ. The following sub-processes are repeated for a total of R times based on the obtained m:

a. m n-bit quantum gates {G₁, . . . , Gₘ} are randomly generated, wherein these quantum gates are composed of quantum gates in the set Ω of fundamental gates supported by the quantum computer by building blocks.

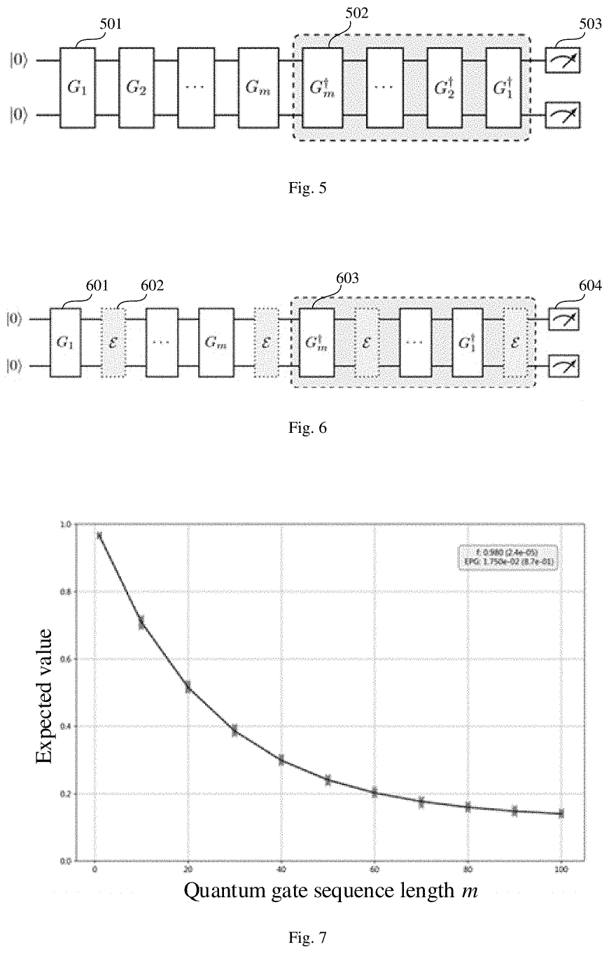

b. The m quantum gates generated in the step (1) are applied to an initial quantum state |0 . . . 0> in the order of G₁, G₂, . . . , Gₘ, as shown in quantum gates 501 in FIG. 5.

c. Quantum gates {G₁^{†}, . . . , Gₘ^{†}} corresponding to respective inverse operations of the m quantum gates {G₁, . . . , Gₘ} are applied to the quantum state generated in the previous step in the order of Gₘ^{†}, Gₘ₋₁^{†}, . . . , G₁^{†}, as shown in quantum gates 502 in FIG. 5. That is, the m quantum gates {G₁, . . . , Gₘ} and the quantum gates {G₁^{†}, . . . , Gₘ^{†}} corresponding to the respective inverse operations of the m quantum gates are arranged in sequence to generate a randomized benchmarking quantum circuit, so as to apply the quantum circuit to the initial quantum state of the system. Because Gᵢ(i=1, . . . , m) is composed of fundamental gates supported by the quantum computer, its inverse quantum gate simply needs to replace the corresponding fundamental gate with the corresponding inverse operation and then reverse the order of action. A quantum state ρ output by the randomized benchmarking quantum circuit is obtained.

d. As shown in FIG. 5, the number S₀ of occurrences of the all-zero sequence 0 . . . 0 is counted based on standard basis measurements on the quantum state ρ for a total of S times by a measurement device 503. Because the measurements result in quantum state collapse, “performing standard basis measurements for S times” requires generating S quantum states ρ, i.e., the randomized benchmarking quantum circuit is repeatedly applied to the initial quantum state for a total of S times.

According to the statistical data obtained in the step (4), an observed expected value is calculated based on a formula (3):

$$p ( r \vert m ) = \frac{{s}_{0}}{s} \qquad Formula ( 3 )$$

wherein p(r|m) represents an estimated probability of “observing the all-zero sequence 0 . . . 0” at the r-th round when the circuit length is m. If the quantum computer does not contain noise, then p(r)=1. However, because the quantum computer contains noise (each quantum gate is affected by noise, resulting in evolutionary results not reaching expectations), p(r)<1 and the magnitude of p(r) directly reflects the noise level of the quantum computer.

The above obtained R observed values p(r) (r=1, . . . , R) are averaged to obtain an average expected value p(m) when the circuit length is m, as shown in a formula (4).

$$p ( m ) = \frac{1}{R} {\sum }_{r = 1}^{R} p ( r \vert m ) \qquad Formula ( 4 )$$

The average expected value p(m) characterizes the average probability that the all-zero sequence 0 . . . 0 can be observed when the circuit length is m, and also characterizes the average noise intensity of the quantum computer from the side.

For each element in the set Σ, the above operations are performed to obtain the average expected value p(m) corresponding to the corresponding m value until the set Σ is an empty set.

A dataset {p(m)|m∈Σ_{bk}} is obtained when each length value in the set Σ of sequence lengths for performing randomized benchmarking on the quantum computer is subjected to the test process described above. Thus, in some embodiments, based on length value information in the backup set Σ_{bk} and the obtained dataset {p(m)|m∈Σ_{bk}}, the objective function can be fitted as shown in a formula (5):

f(m)=Af^{2m-1}+B Formula (5)

wherein, the coefficients A and B that are to be fitted absorb noise that may appear in quantum state preparation and measurement error (SPAM), while the coefficient f characterizes an average precision of the quantum computer implementing a n-qubit quantum gate that is to be determined. A fitting coefficient 2m−1 (i.e., the highest power) in the formula (5) is a main difference from a standard randomized benchmarking method.

According to some embodiments, the objective function can be fitted as shown in a formula (6):

f(m)=Af^{2m-1}+Bf^{2m-2}+ . . . +Cf+D Formula (6)

wherein A, B, . . . , C, and D are coefficients that are to be fitted, and f represents the average precision of the quantum computer implementing a n-bit quantum gate that is to be determined.

It can be understood that the form of the objective function is not limited to those shown in the formulae (5) and (6), and any number of other powers may be included in addition to the highest power 2m−1, which is not limited here.

As described above, the average noise intensity of the quantum computer implementing n-qubit quantum gates can be further determined according to the formula (2). Thus, the quantum computer under test can be calibrated with the average noise intensity.

In the embodiments according to the present disclosure, by continuously adjusting the number of quantum gates in the randomized benchmarking circuit, sampling data of the randomized benchmarking circuit at different depths are obtained, and finally the average noise of the quantum computer is calculated by the fitting method.

In one exemplary application according to the present disclosure, a randomized benchmarking solution according to the embodiments of the present disclosure is tested on an IBM Qiskit noisy simulator. The test parameters may be selected as: the number n of qubits being equal to 3, a set Σ={1, 10, 20, 30, . . . , 100} of sequence lengths, the number R of repetitions of each sequence length being equal to 100, and the number S of repeated runs of each quantum circuit being equal to 8192. The set Ω of fundamental gates supported by the quantum computer is any set of quantum gates.

In particular, one given quantum noise channel ϵ is inserted behind each random n-bit quantum gate for simulating a noise behavior of the quantum computer. That is, ideal G quantum gates are theoretically desired to be implemented, but quantum computers actually implement quantum evolution ϵ∘G(·)G^{†}. In a randomly calibrated quantum circuit shown in FIG. 5, a total of 2m quantum noise channels ϵ need to be inserted, and the resulting noisy randomly calibrated quantum circuit is shown in FIG. 6, wherein random quantum gates 601, quantum noise channels 602, and quantum gates 603 corresponding to inverse operations of the random quantum gates are connected sequentially, and the output quantum states are subjected to standard basis measurements via a measurement device 604 to count the number of occurrences of the all-zero sequence 0 . . . 0.

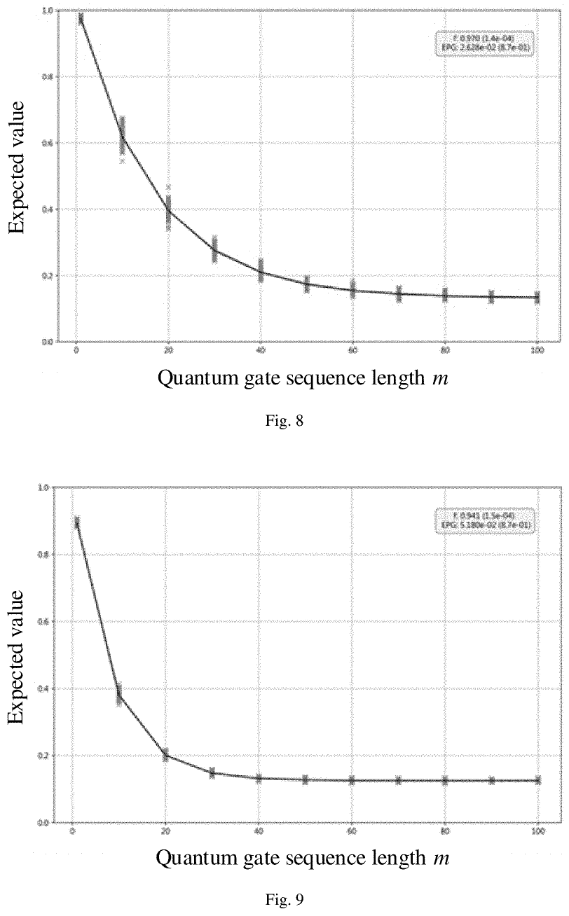

Exemplarily, in numerical simulation experiments, three quantum noises are considered: global depolarizing noise, single-qubit amplitude damping noise, and single-qubit bit-flip noise. For the case of multiple qubits, the latter two noises assume that all qubits suffer from the same single-qubit noise, and the simulation results are shown in FIGS. 7-9, respectively.

As can be seen from FIGS. 7-9, the simulation data results reflect the correctness of the method according to the present disclosure well, and the average precision of the corresponding noise can be obtained by successfully fitting different noise types, wherein an f value in the figures is an average precision obtained by fitting, and EPG corresponds to an average noise intensity obtained by fitting.

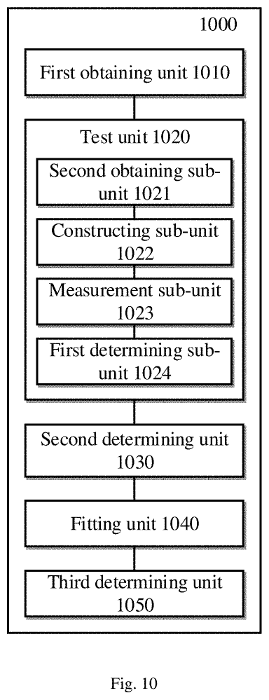

According to the embodiments of the present disclosure, as shown in FIG. 10, also provided is a device 1000 for characterizing a performance of a quantum computer, including: a first obtaining unit 1010, configured to obtain a set of sequence lengths for performing randomized benchmarking on the quantum computer; a test unit 1020, configured to perform, for each sequence length m in the set of sequence lengths, the following operations for R times, wherein m and R are both positive integers: a second obtaining unit 1021, configured to obtain m n-bit quantum gates that are randomly generated, and quantum gates corresponding to respective inverse operations of the m n-bit quantum gates, wherein n is a positive integer; a constructing unit 1022, configured to construct a quantum circuit, wherein in the quantum circuit, the m n-bit quantum gates are sequentially connected in a first order, and the quantum gates corresponding to the respective inverse operations of the m n-bit quantum gates are sequentially connected behind the m n-bit quantum gates in an order opposite to the first order; a measurement unit 1023, configured to apply an initial quantum state to the quantum circuit to perform a plurality of standard basis measurements on a quantum state output by the quantum circuit; and a first determining unit 1024, configured to determine a number of occurrences of an all-zero sequence in the plurality of standard basis measurements to calculate an expected value based on the number of occurrences; a second determining unit 1030, configured to determine, for each m, an average expected value obtained after R operations; a fitting unit 1040, configured to fit an objective function based on the average expected value corresponding to each m, wherein for each m, a highest power of the objective function is 2m−1; and a third determining unit 1050, configured to determine an average precision of the quantum computer implementing a n-bit quantum gate based on a result of the fitting.

Here, the operations of the above-described units 1010-1050 of the device 1000 for characterizing the performance of the quantum computer are similar to the operations of the previously described steps 410-450, respectively, and will not be repeated here.

According to the embodiments of the present disclosure, an electronic device, a readable storage medium, and a computer program product are also provided.

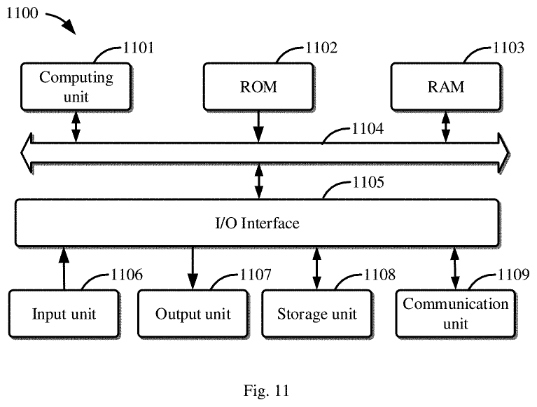

With reference to FIG. 11, a structural block diagram of an electronic device 1100 that can serve as a server or client of the present disclosure will now be described, which is an example of a hardware device that can be applied to various aspects of the present disclosure. The electronic device is intended to represent various forms of digital electronic computer devices, such as laptops, desktops, workstations, personal digital assistants, servers, blade servers, mainframe computers, and other appropriate computers. The electronic device may also represent various forms of mobile devices, such as personal digital processors, cellular telephones, smartphones, wearable devices, and other similar computing devices. The components shown herein, their connections and relationships, and their functions are provided by way of example only, and are not intended to limit implementations of the present disclosure described and/or claimed herein.

As shown in FIG. 11, the electronic device 1100 includes a computing unit 1101 which can perform various appropriate actions and processes in accordance with a computer program stored in a read only memory (ROM) 1102 or a computer program loaded from a storage unit 1108 into a random access memory (RAM) 1103. In the RAM 1103, various programs and data necessary for the operation of the electronic device 1100 may also be stored. The computing unit 1101, the ROM 1102 and the RAM 1103 are connected to each other by a bus 1104. An input/output (I/O) interface 1105 is also connected to the bus 1104.

A plurality of components in the electronic device 1100 are connected to the I/O interface 1105, including an input unit 1106, an output unit 1107, a storage unit 1108, and a communication unit 1109. The input unit 1106 can be any type of device capable of inputting information to the electronic device 1100, and the input unit 1106 may receive input numeric or character information and generate key signal input related to user setting and/or function control of the electronic device, and may include, but is not limited to, a mouse, a keyboard, a touch screen, a trackpad, a trackball, a joystick, a microphone, and/or a remote control. The output unit 1107 may be any type of device capable of presenting information and may include, but is not limited to, a display, a speaker, a video/audio output terminal, a vibrator, and/or a printer. The storage unit 1108 may include, but is not limited to, a magnetic disk and an optical disk. The communication unit 1109 allows the electronic device 1100 to exchange information/data with other devices through a computer network such as the Internet and/or various telecommunication networks, and may include, but is not limited to, a modem, a network card, an infrared communication device, a wireless communication transceiver, and/or a chipset, such as a Bluetooth™ device, a 802.11 device, a WiFi device, a WiMax device, a cellular communication device, and/or the like.

The computing unit 1101 may be a variety of general and/or special processing components with processing and computing capabilities. Some examples of the computing unit 1101 include, but are not limited to, a central processing unit (CPU), a graphics processing unit (GPU), various special artificial intelligence (AI) computing chips, various computing units running machine learning model algorithms, a digital signal processor (DSP), and any suitable processor, controller, microcontroller, or the like. The computing unit 1101 executes the various methods and processes described above, such as the method 400. For example, in some embodiments, the method 400 may be implemented as a computer software program tangibly embodied in a machine-readable medium, such as the storage unit 1108. In some embodiments, part or all of the computer programs may be loaded into and/or installed on the electronic device 1100 via the ROM 1102 and/or the communication unit 1109. The computer program, when loaded into the RAM 1103 and executed by the computing unit 1101, may perform one or more steps of the method 400 described above. Alternatively, in other embodiments, the computing unit 1101 may be configured in any other suitable manner (e.g., by means of firmware) to perform the method 400.

Various implementations of the systems and technologies described above in this paper may be implemented in a digital electronic circuit system, an integrated circuit system, a field programmable gate array (FPGA), an application specific integrated circuit (ASIC), an application specific standard part (ASSP), a system on chip (SOC), a complex programmable logic device (CPLD), computer hardware, firmware, software and/or their combinations. These various implementations may include: being implemented in one or more computer programs, wherein the one or more computer programs may be executed and/or interpreted on a programmable system including at least one programmable processor, and the programmable processor may be a special-purpose or general-purpose programmable processor, and may receive data and instructions from a storage system, at least one input apparatus, and at least one output apparatus, and transmit the data and the instructions to the storage system, the at least one input apparatus, and the at least one output apparatus.

Program codes for implementing the methods of the present disclosure may be written in any combination of one or more programming languages. These program codes may be provided to processors or controllers of a general-purpose computer, a special-purpose computer or other programmable data processing apparatuses, so that when executed by the processors or controllers, the program codes enable the functions/operations specified in the flow diagrams and/or block diagrams to be implemented. The program codes may be executed completely on a machine, partially on the machine, partially on the machine and partially on a remote machine as a separate software package, or completely on the remote machine or server.

In the context of the present disclosure, a machine readable medium may be a tangible medium that may contain or store a program for use by or in connection with an instruction execution system, apparatus or device. The machine readable medium may be a machine readable signal medium or a machine readable storage medium. The machine readable medium may include but not limited to an electronic, magnetic, optical, electromagnetic, infrared, or semiconductor system, apparatus or device, or any suitable combination of the above contents. More specific examples of the machine readable storage medium will include electrical connections based on one or more lines, a portable computer disk, a hard disk, a random access memory (RAM), a read only memory (ROM), an erasable programmable read only memory (EPROM or flash memory), an optical fiber, a portable compact disk read only memory (CD-ROM), an optical storage device, a magnetic storage device, or any suitable combination of the above contents.

In order to provide interactions with users, the systems and techniques described herein may be implemented on a computer, and the computer has: a display apparatus for displaying information to the users (e.g., a CRT (cathode ray tube) or LCD (liquid crystal display) monitor); and a keyboard and a pointing device (e.g., a mouse or trackball), through which the users may provide input to the computer. Other types of apparatuses may further be used to provide interactions with users; for example, feedback provided to the users may be any form of sensory feedback (e.g., visual feedback, auditory feedback, or tactile feedback); an input from the users may be received in any form (including acoustic input, voice input or tactile input).

The systems and techniques described herein may be implemented in a computing system including background components (e.g., as a data server), or a computing system including middleware components (e.g., an application server) or a computing system including front-end components (e.g., a user computer with a graphical user interface or a web browser through which a user may interact with the implementations of the systems and technologies described herein), or a computing system including any combination of such background components, middleware components, or front-end components. The components of the system may be interconnected by digital data communication (e.g., a communication network) in any form or medium. Examples of the communication network include: a local area network (LAN), a wide area network (WAN) and the Internet.

A computer system can include a client and a server. The client and the server are generally far away from each other and typically interact through a communication network. A relationship between the client and the server is generated by computer programs running on the corresponding computers and having a client-server relationship with each other. The server may be a cloud server, or a server of a distributed system, or a server combined with a blockchain.

It should be understood that various forms of processes shown above can be used to reorder, add, or delete steps. For example, the steps recited in the present disclosure can be performed in parallel, or in sequence or in a different order, as long as the desired results of the technical solution of the present disclosure can be achieved, which is not limited herein.

Although the embodiments or examples of the present disclosure have been described with reference to the accompanying drawings, it should be understood that the methods, systems and devices described above are merely exemplary embodiments or examples and that the scope of the present disclosure is not limited by these embodiments or examples, but only limited by the authorized claims and their equivalents. Various elements in the embodiments or examples may be omitted or may be replaced by equivalents thereof. Furthermore, the steps may be performed in an order different from that described in the present disclosure. Further, various elements in the embodiments or examples may be combined in various ways. Importantly, as technology evolves, many of the elements described herein may be replaced by equivalent elements that appear after the present disclosure.

1. A computer-implemented method, comprising:
obtaining a set of sequence lengths for performing randomized benchmarking on a quantum computer;
performing, for each sequence length m in the set of sequence lengths, the following operations for R times, wherein m and R are both positive integers:
obtaining m n-bit quantum gates that are randomly generated, and quantum gates corresponding to respective inverse operations of the m n-bit quantum gates, wherein n is a positive integer,
constructing a quantum circuit, wherein in the quantum circuit, the m n-bit quantum gates are sequentially connected in a first order, and the quantum gates corresponding to the respective inverse operations of the m n-bit quantum gates are sequentially connected behind the m n-bit quantum gates in an order opposite to the first order,
applying an initial quantum state to the quantum circuit to perform a plurality of standard basis measurements on a quantum state output by the quantum circuit, and
determining a number of occurrences of an all-zero sequence in the plurality of standard basis measurements to calculate an expected value based on the number of occurrences;
determining, for each sequence length m, an average expected value obtained after R operations;
fitting an objective function based on the average expected value corresponding to each sequence length m, wherein for each sequence length m, a highest power of the objective function is 2m−1; and
determining an average precision of the quantum computer implementing a n-bit quantum gate based on a result of the fitting.

2. The method according to claim 1, further comprising determining an average noise intensity of the quantum computer implementing the n-bit quantum gate based on the average precision.

3. The method according to claim 1, wherein the objective function comprises the following form:
f(m)=Af^{2m-1}+B
wherein A and B are coefficients that are to be fitted, and f represents the average precision of the quantum computer implementing the n-bit quantum gate that is to be determined.

4. The method according to claim 1, wherein the objective function comprises the following form:
f(m)=Af^{2m-1}+Bf^{2m-2}+ . . . +Cf 30 D
wherein A, B, . . . , C and D are coefficients that are to be fitted, and f represents the average precision of the quantum computer implementing a n-bit quantum gate that is to be determined.

5. The method according to claim 2, wherein the average noise intensity of the quantum computer implementing the n-bit quantum gate is determined according to the following formula:
$${r}_{E P G} = \frac{{2}^{n} - 1}{{2}^{n}} ( 1 - f )$$
wherein f represents the average precision of the quantum computer implementing a n-bit quantum gate that is to be determined.

6. An electronic device, comprising:
a memory storing one or more programs configured to be executed by one or more processors, the one or more programs including instructions for causing the electronic device to perform operations comprising:
obtaining a set of sequence lengths for performing randomized benchmarking on a quantum computer;
performing, for each sequence length m in the set of sequence lengths, the following operations for R times, wherein m and R are both positive integers:
obtaining m n-bit quantum gates that are randomly generated, and quantum gates corresponding to respective inverse operations of the m n-bit quantum gates, wherein n is a positive integer,
constructing a quantum circuit, wherein in the quantum circuit, the m n-bit quantum gates are sequentially connected in a first order, and the quantum gates corresponding to the respective inverse operations of the m n-bit quantum gates are sequentially connected behind the m n-bit quantum gates in an order opposite to the first order,
applying an initial quantum state to the quantum circuit to perform a plurality of standard basis measurements on a quantum state output by the quantum circuit, and
determining a number of occurrences of an all-zero sequence in the plurality of standard basis measurements to calculate an expected value based on the number of occurrences;
determining, for each sequence length m, an average expected value obtained after R operations;
fitting an objective function based on the average expected value corresponding to each sequence length m, wherein for each sequence length m, a highest power of the objective function is 2m−1; and
determining an average precision of the quantum computer implementing a n-bit quantum gate based on a result of the fitting.

7. The electronic device according to claim 6, the operations further comprising determining an average noise intensity of the quantum computer implementing the n-bit quantum gate based on the average precision.

8. The electronic device according to claim 6, wherein the objective function comprises the following form:
f(m)=Af^{2m-1}+B
wherein A and B are coefficients that are to be fitted, and f represents the average precision of the quantum computer implementing the n-bit quantum gate that is to be determined.

9. The electronic device according to claim 6, wherein the objective function comprises the following form:
f(m)=Af^{2m-1}+Bf^{2m-2}+ . . . +Cf+D
wherein A, B, . . . , C and D are coefficients that are to be fitted, and f represents the average precision of the quantum computer implementing the n-bit quantum gate that is to be determined.

10. The electronic device according to claim 7, wherein the average noise intensity of the quantum computer implementing a n-bit quantum gate is determined according to the following formula:
$${r}_{E P G} = \frac{{2}^{n} - 1}{{2}^{n}} ( 1 - f )$$
wherein f represents the average precision of the quantum computer implementing the n-bit quantum gate that is to be determined.

11. A non-transitory computer-readable storage medium that stores one or more programs comprising instructions that, when executed by one or more processors of a computing device, cause the computing device to implement operations comprising:
obtaining a set of sequence lengths for performing randomized benchmarking on a quantum computer;
performing, for each sequence length m in the set of sequence lengths, the following operations for R times, wherein m and R are both positive integers:
obtaining m n-bit quantum gates that are randomly generated, and quantum gates corresponding to respective inverse operations of the m n-bit quantum gates, wherein n is a positive integer,
constructing a quantum circuit, wherein in the quantum circuit, the m n-bit quantum gates are sequentially connected in a first order, and the quantum gates corresponding to the respective inverse operations of the m n-bit quantum gates are sequentially connected behind the m n-bit quantum gates in an order opposite to the first order,
applying an initial quantum state to the quantum circuit to perform a plurality of standard basis measurements on a quantum state output by the quantum circuit, and
determining a number of occurrences of an all-zero sequence in the plurality of standard basis measurements to calculate an expected value based on the number of occurrences;
determining, for each sequence length m, an average expected value obtained after R operations;
fitting an objective function based on the average expected value corresponding to each sequence length m, wherein for each sequence length m, a highest power of the objective function is 2m≤1; and
determining an average precision of the quantum computer implementing a n-bit quantum gate based on a result of the fitting.

12. The non-transitory computer-readable storage medium according to claim 11, the operations further comprising determining an average noise intensity of the quantum computer implementing the n-bit quantum gate based on the average precision.

13. The non-transitory computer-readable storage medium according to claim 11, wherein the objective function comprises the following form:
f(m)=Af^{2m-1}+B
wherein A and B are coefficients that are to be fitted, and f represents the average precision of the quantum computer implementing the n-bit quantum gate that is to be determined.

14. The non-transitory computer-readable storage medium according to claim 11, wherein the objective function comprises the following form:
f(m)=Af^{2m-1}+Bf^{2m-2}+ . . . +Cf+D
wherein A, B, . . . , C and D are coefficients that are to be fitted, and f represents the average precision of the quantum computer implementing the n-bit quantum gate that is to be determined.

15. The non-transitory computer-readable storage medium according to claim 12, wherein the average noise intensity of the quantum computer implementing a n-bit quantum gate is determined according to the following formula:
$${r}_{E P G} = \frac{{2}^{n} - 1}{{2}^{n}} ( 1 - f )$$
wherein f represents the average precision of the quantum computer implementing the n-bit quantum gate that is to be determined.
